(19) United States
(12) Patent Application Publication
(10) Pub. No.: US 2018/0154396 A1
(43) Pub. Date: Jun. 7, 2018

(54) Method and Machine for Sorting Bags

(71) Applicant: Holweg Group, Molsheim (FR)

(72) Inventor: Cedric Ritondo, Eschau (FR)

(73) Assignee: Holweg Group, Molsheim (FR)

(21) Appl. No.: 15/565,965

(22) PCT Filed: Apr. 7, 2016
(86) PCT No.: PCT/FR2016/050809

§ 371 Date: Jan. 15, 2018

(30) Foreign Application Priority Data
Apr. 14, 2015 (FR) 1553245

(51) Int. Cl. B07C 5/12; B07C 5/10; B07C 5/06

(52) U.S. Cl. CPC B07C 5/12; B07C 5/06; B07C 5/10

(57) ABSTRACT

method for sorting bags bags includes filing past flat one after the other while being separated by a gap; the exterior edges of each bag are checked to determine whether the template and the position of the bag correspond to a calibrated bag or non-calibrated bag, the non-calibrated bags are ejected, the calibrated bags are presented in front of a visual inspection system to determine an acceptable or unacceptable quality of the inspected bag; and the acceptable bags are stacked and the unacceptable bags are rejected after they have passed in front of the visual inspection system. The invention also relates to a machine implementing the method.

### TECHNICAL FIELD

The present invention relates to a method for sorting bags, after their production, by a visual inspection system. It relates also to a sorting machine implementing said method.

### STATE OF THE ART

The manufacturing of bags, such as paper bags for example, is performed on machines working continuously from a strip of material on a reel or from precut sheets on a stack, such as all-paper, or paper with parts of plastic material, on which folding, cutting and gluing operations are in particular carried out. The finished bags leave the machine, for example, flat one after the other separated by a gap before being received by a stacker device which forms stacks. The transporting of the bags is performed between pairs of rollers distributed over the path or by pairs of conveyor belts mounted in loop fashion and which run on either side of the bags.

The production rates can be high and reach several hundreds of pieces per minute.

It may be that, in transient start-up phases or when production parameters change, bags of poor quality are produced. Even if operators are monitoring the production, they cannot react instantaneously such that products of poor quality are mixed with products of good quality.

The document EP 2 433 872 proposes performing a poor quality bag detection operation, by interposing, between the production machine and the stacker device, a visual inspection system. The stacker device downstream of the inspection system comprises a sorting device for stacking only the bags that are considered acceptable by the visual inspection system. The unacceptable bags run on without being stacked and are collected later after having passed through the stacking zone. The inspection system comprises a station where the bags rest on just one side on conveyor belts, in order to allow a complete visual access to the face of the bag opposite the conveyor belts. This station comprises a lighting device and a camera or several cameras. It makes it possible to check various parameters, such as the presence of handles, their number, their position, the quality of the bottom fold of the bag, the quality of the printing or the presence of glue.

Such a system has proven effective in most cases. However, during the phases of adjustment, of restart after a stoppage, or in case of various incidents, it may be that the condition of the bag on leaving the machine is so poor that the bag cannot pass through the inspection system, particularly at the station in which the bag is supported by the conveyor belts only on one face, and it may cause a jam. It is then a matter of urgency to shut down the production to manually clear the jam.

### DESCRIPTION OF THE INVENTION

The invention aims to provide a method and a machine for sorting by visual inspection which remedy these problems, in particular which do not introduce risks of jams when bags of very poor quality leave the production machine.

With these objectives in mind, the subject of the invention is a bag sorting method whereby:

bags are provided flat, filing one after the other while being separated by a gap;

each bag is presented in front of a visual inspection system to determine an acceptable or unacceptable quality of the bag inspected; and

the acceptable bags are stacked and the unacceptable bags are rejected after they have passed in front of the visual inspection system;

the method being characterized in that, before the visual inspection, the outer edges of each bag are checked to determine whether the template and the position of the bag correspond to a calibrated bag or non-calibrated bag, the non-calibrated bags are ejected upstream of the visual inspection system, and the calibrated bags are presented to the visual inspection system.

According to the invention, a first sort is applied which can be implemented easily, for example by using cells such as optical, mechanical cells or capacitive, inductive or similar presence sensors, so as to determine whether the bag haves major defects with respect to its outer dimensions. In fact, the risks of jamming stem from bags with parts that are partially detached, folded back or torn. These defects are reflected by significant deviations from the template of the bag and are detected easily. This sort can be implemented while keeping the bag between the conveyor belts. The discarding of such bags greatly reduces the risks of jamming, particularly at the visual inspection system when the bags are less well held. The defect detection can also be performed in a complementary manner on the production machine, with, for example, glue presence sensors (based on humidity or heat in the case of hot glue).

According to one embodiment, a bag is determined to be non-calibrated if the width or the length of the bag is outside of a predetermined range. By determining the position of the longitudinal edges, the width of the bag is determined. If it is outside of an interval around the expected value, it is deduced therefore that the bag haves a defect and that it is not calibrated. Similarly, by determining the position of the front and rear edges, the length of the bag is determined. If the latter is outside of an interval around the expected value, it is deduced therefrom that the bag haves a defect, such as a badly cut edge, a badly folded back tab or a part torn away. The bag is then declared non-calibrated.

According to another embodiment, a bag is also determined to be non-calibrated if its front edge is separated from the rear edge of the preceding bag by a gap greater than a predetermined threshold. A distance greater than or less than the expected value is the sign of an anomaly on the bag which is thus declared non-calibrated.

According to yet another embodiment, a bag is determined to be non-calibrated if its front edge is separated from the rear edge of the preceding bag by an interval greater than a first predetermined threshold or less than a second predetermined threshold. Thus, the length of the bag is determined, which should lie between the first threshold and the second threshold to be considered to be that of a calibrated bag.

According to yet another embodiment, a bag is also declared non-calibrated if its thickness is greater than a predetermined threshold; for example, a device which is raised upon the passage of bags that are too thick activates a contactor and the bag is thus declared non-calibrated. An abnormal great thickness is generally linked to the superpositioning of layers of the constituent material in a nonconforming manner.

Another subject of the invention is a bag sorting machine comprising:

an input for receiving bags flat, filing one after the other while being separated by a gap;

a visual inspection system for making the bags file in front of an optical apparatus and for determining an acceptable or unacceptable quality of the bag inspected; and

a selection system for rejecting the unacceptable bags and stacking the acceptable bags;

the machine being characterized in that it comprises a checking station between the input and the visual inspection system for checking the outer edges of each bag and determining whether the template and the position of the bag correspond to a calibrated or non-calibrated bag, and a switch upstream of the visual inspection system for ejecting the non-calibrated bags.

According to one constructive embodiment, the switch comprises a nose mounted to pivot about a transverse axis, the nose comprising an end and pivoting between a receded position in which the bags follow a path to the visual inspection system along an outer face of the nose, and a raised position in which the end of the nose protrudes to orient the front of the bag which is displaced on the side of an inner face of the nose opposite the outer face. The nose is interposed at the front of the non-calibrated bag to steer it to a path other than to the inspection system. The bag continues in its displacement, but taking the other path.

### BRIEF DESCRIPTION OF THE FIGURES

The invention will be better understood and other particular features and advantages will become apparent on reading the following description, the description referring to:

FIG. 1 which is a schematic view of a sorting machine according to an embodiment of the invention.

### DETAILED DESCRIPTION

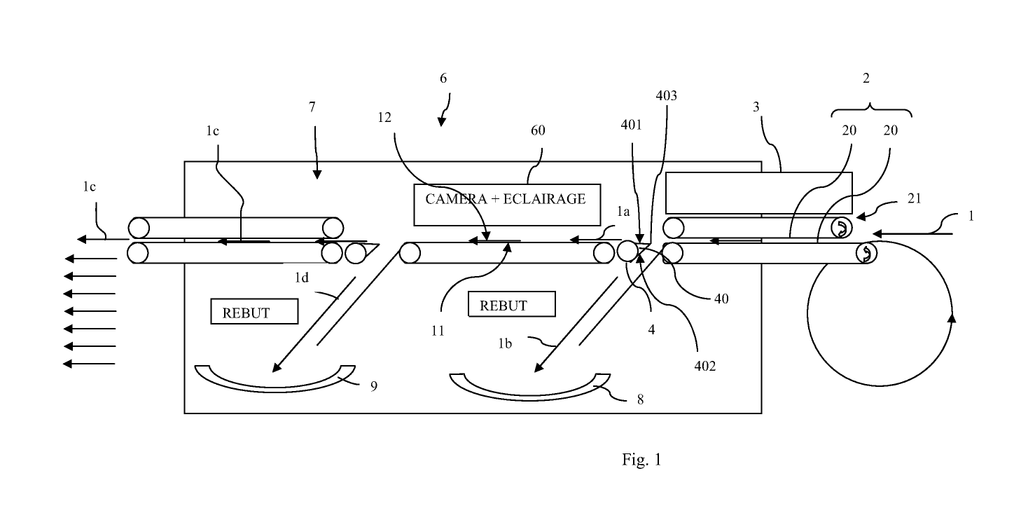

A bag sorting machine according to the invention is represented in FIG. 1. The machine is designed to receive bags 1 at the output of a machine for manufacturing said bags 1 and comprises, in succession in the direction of displacement of the bags 1:

an input 21 for receiving bags 1 filing flat one after the other while being separated by a gap;

first transport means 2 for making the bags 1 run in front of a checking station 3 to check the outer edges of each bag and determine whether the template and the position of the bag correspond to a calibrated bag 1a or non-calibrated bag 1b;

a switch 4 for ejecting the non-calibrated bags 1b;

second transport means 5 for transporting the calibrated bags 1a to

a visual inspection system 6 to make the calibrated bags 1a run in front of an optical apparatus 60 and to determine an acceptable or unacceptable quality of the bag inspected; and

a selection system 7 for rejecting the unacceptable bags 1d and stacking the acceptable bags 1c.

The first transport means 2 are formed conventionally by pairs of conveyor belts 20 mounted in loop fashion and between which the bags 1 run. The checking station 3 comprises, for example, several photoelectric cells emitting and receiving a light beam that can be interrupted by the bag to be checked. The edges of the bag in the direction of transportation must interrupt the beam of a first cell and not interrupt the beam of a second cell adjacent to the first, and do so within a time interval corresponding to the theoretical period of passage of the bag. If, during this interval, the beam from the second cell is interrupted or if the beam from the first cell is not, the bag is considered to have a defect. Other combinations of checks can be implemented. The first cell makes it possible to detect the gap between the front edge of a bag and the rear edge of the preceding bag. If this gap is greater than a predetermined threshold, the front edge of the bag is delayed and the bag is considered to have a defect.

It is also possible to check the thickness of the bag, which makes it possible to determine whether the bags have a major formation defect and to choose whether or not they should be immediately discarded. The check is, in this case, performed for example by a feeler provided with a shoe, a roller bearing elastically on the filing bags or by a laser or ultrasound sensor.

Moreover, some of these checks can be performed upstream, on the manufacturing machine, the checking station receiving the nonconformity information by being able to determine the moment at which the non-calibrated bag passes the switch.

Downstream of the checking station 3, the switch 4 can be actuated rapidly according to the result supplied by the checking station 3. The switch 4 comprises a nose 40 mounted to pivot about a transverse axis between a receded position in which the calibrated bags 1a follow a path to the visual inspection system 6 along an outer face 401 of the nose 40, and a raised position in which an end of the nose 40 protrudes to steer the front of the non-calibrated bag 1b which is displaced on the side of an inner face 402 of the nose 40 opposite the outer face 401. The non-calibrated bags 1b are sent for example to a first recovery bin 8.

Calibrated bags 1a are taken over by the second transport means 5 to be brought to the visual inspection system 6. Contrary to the conventional transport means, the second transport means 5 support the bags 1a on just one face 11, such that the opposite face 12 is totally clear and visually accessible. The visual inspection system 6 determines whether the bag inspected is acceptable or not. The bag 1 is then delivered to the selection system 7 which is configured to stack the acceptable bags 1c and steer the unacceptable bags 1d to a second recovery bin 9.

1.-6. (canceled)

7. A bag sorting method comprising:
providing flat bags separated by a gap;
presenting each bag in front of a visual inspection system to determine an acceptable quality of the bag or an unacceptable quality of the bag and thereafter stacking acceptable bags and rejecting unacceptable bags;
wherein before the visual inspection, outer edges of each bag are checked to determine whether a template and a position of the bag correspond to a calibrated bag or a non-calibrated bag, such that non-calibrated bags are ejected upstream of the visual inspection system, and the calibrated bags are presented to the visual inspection system.

8. The method according to claim 7, wherein a bag is determined to be non-calibrated if a width or a length of the bag is outside of a predetermined range.

9. The method according to claim 7, wherein the checking of the outer edges of each bag is performed by a checking station that includes a first photoelectric cell and a second photoelectric cell positioned adjacent to the first, each of the photoelectric cells emitting and receiving a light beam that can be interrupted by the bag to be checked, and wherein the checking the outer edges of each bag includes determining if the outer edges of the bag in the direction of transportation interrupt the beam of the first cell and not the beam of the second cell within a time period corresponding to the period of theoretic passage of the bag and if the beam from the second cell is interrupted within the time period or if the beam from the first cell is not interrupted, the bag is considered to have a defect.

10. The method according to claim 7, wherein a bag is determined to be non-calibrated if a front edge is separated from a rear edge of a preceding bag by a gap greater than a predetermined threshold.

11. The method according to claim 10, wherein the checking of the outer edges of each bag is performed by a checking station that includes a plurality of photoelectric cells emitting and receiving a light beam that can be interrupted by the bag to be checked, wherein a first photoelectric cell is arranged to detect the gap between the front edge of a bag and the rear edge of the preceding bag and wherein when checking the outer edges of each bag the first photoelectric cell detects the gap between the front edge of the bag and the rear edge of the preceding bag and if the gap detected is greater than a predetermined threshold, the bag is considered to have a defect.

12. The method according to claim 7 wherein each bag has a thickness and a bag is determined to be non-calibrated when the thickness is greater than a predetermined threshold.

13. A bag sorting machine comprising:
an input for receiving bags separated by a gap;
a visual inspection system that presents each bag to pass in front of an optical apparatus for inspection and determines determining an acceptable quality of the inspected bag or unacceptable quality of the inspected bag; and
a selection system that rejects the unacceptable bags and stacks the acceptable bags;
a checking station located between the input and the visual inspection system, wherein the checking station checks outer edges of each bag and determines whether a template and a position of the bag correspond to a calibrated bag or a non-calibrated bag; and
a switch upstream of the visual inspection system for ejecting the non-calibrated bags.

14. The machine according to claim 13, wherein the switch comprises a nose mounted to pivot about a transverse axis, the nose having an end and pivoting between a receded position in which the bags follow a path to the visual inspection system along an outer face of the nose, and a raised position in which the end of the nose protrudes to orient a front of the bag which is displaced on a side of an inner face of the nose opposite the outer face.

15. The machine according to claim 13 further comprising a checking station that includes several cells to check outer edges of each bag and to determine whether the template and the position of the bag correspond to the calibrated bag or the non-calibrated bag.

16. The machine according to claim 15, wherein the cells are selected from at least one of an optical cell, a mechanical cell, a capacitive sensor, an inductive presence sensor, or a combination thereof.

17. The machine according to claim 15, wherein the cells are photoelectric cells.

18. The machine as claimed according to claim 13 further comprising a detector to measure a thickness of each bag and when the thickness is greater than a predetermined threshold, the bag is determined to be non-calibrated.

19. The machine according to claim 18, wherein the detector includes a feeler provided with a shoe or a roller bearing elastically on the bags to check the thickness of the bag.

20. The machine according to claim 18, wherein the detector includes a laser or ultrasound sensor to check the thickness of the bag.
